(19) United States
(12) Patent Application Publication
(10) Pub. No.: US 2014/0059341 A1
(43) Pub. Date: Feb. 27, 2014

(54) CREATING AND ACCESSING ENCRYPTED WEB BASED CONTENT IN HYBRID APPLICATIONS

(71) Applicant: Jermaine C. Edwards, Allen, TX (US)

(72) Inventor: Jermaine C. Edwards, Allen, TX (US)

(73) Assignee: International Business Machines Corporation, Armonk, NY (US)

(21) Appl. No.: 13/590,238

(22) Filed: Aug. 21, 2012

(51) Int. Cl. G06F 21/00

(52) U.S. Cl. 713/152

(57) ABSTRACT

In a method and program product for decrypting web based content in a hybrid mobile application, a computer receives a request to access encrypted content. The computer determines that a secret key is not cached on the computer. The computer decrypts an encrypted secret key to expose the secret key. The computer caches the secret key on the computer and decrypts the encrypted content.

In a program product for encrypting web based content and packaging a hybrid mobile application, the computer program product includes one or more computer-readable tangible storage devices and program instructions stored on at least one of the one or more storage devices, the program instructions include program instructions to receive a command to encrypt web based content and package a hybrid mobile application, to create a secret key, to encrypt the web based content, to encrypt the secret key, and to package the hybrid mobile application.

### TECHNICAL FIELD

The present invention relates generally to hybrid mobile applications, and more specifically to creating and accessing encrypted web based content in hybrid mobile applications.

### BACKGROUND

Hybrid applications are computer applications that contain native and web based application code. Hybrid applications are typically installed in mobile computing devices. Each mobile computing device may have a unique computing platform/operating system. Native application code is written specifically for a certain computing platform. Web based application code is written in HyperText Markup Language (HTML), Cascading Style Sheets (CSS) language, or JavaScript and can be used across different computing platforms. By writing the hybrid application partially in web based application code the entire hybrid application does not need to be rewritten for each unique computing platform. Hybrid applications can include all required web based application code or resources (i.e., HTML, JavaScript, CSS and images) stored locally on the mobile computing device or can be requested from a web server.

Generally, web based application code or resources (i.e., HTML, JavaScript, CSS and images) included in hybrid mobile applications are not stored in a confidential manner and can be easily viewed using a tool such as a standard archiving tool.

Methods of encryption are essential for commerce and many other uses to provide secure electronic communications. Encryption is a process of transforming information using an algorithm to make it unreadable to anyone except those possessing a decryption key.

A commonly used method of encryption for online communications is asymmetric encryption. Public key encryption is a type of asymmetric encryption where a party has a pair of keys. One key is a public key, which can be made freely available to the public. The other key, carefully guarded by the party, is a private key. A message encoded with a public key can only be decoded using the corresponding private key, and vice versa. RSA (Rivest-Shamir-Adleman) is a commonly used asymmetric key algorithm.

In symmetric encryption, the sender and the recipient use the same key to encrypt and decrypt the message. For example, the Advanced Encryption Standard (AES) is a widely used symmetric key algorithm. AES is a cipher with a 128 bit block size and it uses keys of 128, 192 or 256 bits.

### SUMMARY

Aspects of an embodiment of the present invention disclose a method and a program product for decrypting web based content in a hybrid mobile application. A computer receives a first request to access encrypted content from a hybrid mobile application. The computer determines that a secret key is not cached on the computer, and in response, the computer decrypts an encrypted secret key to expose the secret key using an asymmetric key algorithm and a decryption key of an asymmetric key pair. The computer caches the secret key on the computer. The computer decrypts the encrypted content using the secret key and a symmetric key algorithm.

An aspect of an embodiment of the present invention discloses a computer program product for encrypting web based content and packaging a hybrid mobile application. The computer program product includes one or more computer-readable tangible storage devices and program instructions stored on at least one of the one or more storage devices. The program instructions include program instruction to receive a command to encrypt web based content and package a hybrid mobile application, to create a secret key, to encrypt the web based content using the secret key and a symmetric key algorithm, to encrypt the secret key using an encryption key of an asymmetric key pair and an asymmetric key algorithm, and to package the hybrid mobile application.

### BRIEF DESCRIPTION OF THE SEVERAL VIEWS OF THE DRAWINGS

FIG. 1 depicts a diagram of a computing system in accordance with one embodiment of the present invention.

FIG. 2 depicts a flowchart of the steps a mobile application package builder program executing within the computing system of FIG. 1, for encrypting web based content and packaging a mobile application, in accordance with one embodiment of the present invention.

FIG. 3 depicts a flowchart of the steps of a read encrypted content program function executing within the computing system of FIG. 1, for decrypting encrypted web based content in a mobile application, in accordance with one embodiment of the present invention.

FIG. 4 is a block diagram of internal and external components of the enterprise server and the client computer of FIG. 1 in accordance with one embodiment of the present invention.

### DETAILED DESCRIPTION

The present invention will now be described in detail with reference to the figures.

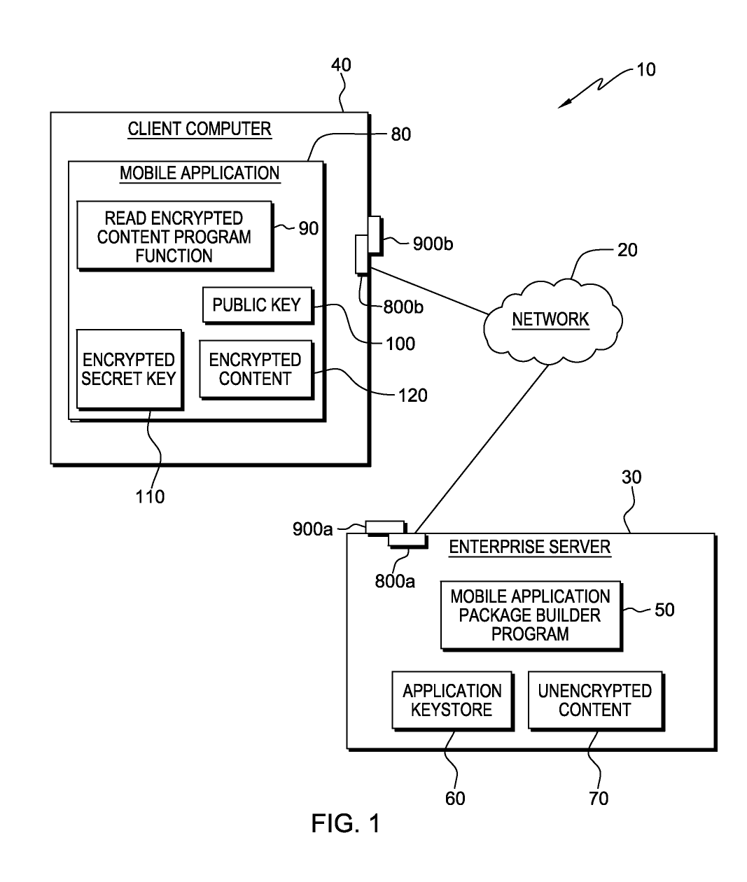

FIG. 1 depicts a diagram of computing system 10 in accordance with one embodiment of the present invention. FIG. 1 provides only an illustration of one embodiment and does not imply any limitations with regard to the environments in which different embodiments may be implemented.

In the depicted embodiment, computing system 10 includes enterprise server 30 and client computer 40 interconnected over network 20. Network 20 may be a local area network (LAN), a wide area network (WAN) such as the Internet, any combination thereof, or any combination of connections and protocols that will support communications between enterprise server 30 and client computer 40 in accordance with embodiments of the invention. Network 20 may include wired, wireless, or fiber optic connections. Computing system 10 may include additional server computers, client computers, or other devices not shown.

Enterprise server 30 may be a management server, a web server, or any other electronic device or computing system capable of receiving and sending data. In other embodiments, enterprise server 30 may represent a server computing system utilizing multiple computers as a server system, such as in a cloud computing environment. Enterprise server 30 contains mobile application package builder program 50, application keystore 60, and unencrypted content 70.

Client computer 40 may be a desktop computer, laptop computer, tablet computer, personal digital assistant (PDA), or smart phone. In general, client computer 40 may be any electronic device or computing system capable of executing computer code, sending and receiving data, and communicating with enterprise server 30 over network 20. Client computer 40 contains mobile application 80, read encrypted content program function 90, public key 100, encrypted secret key 110, and encrypted content 120.

Mobile application package builder program 50 operates to encrypt unencrypted content 70 for use in a mobile application. In one embodiment, mobile application package builder program 50 encrypts unencrypted content 70 for mobile application 80 using a symmetric key algorithm. A “secret key” is the symmetric key used to encrypt unencrypted content 70 using a symmetric key algorithm. The symmetric key is to be “secret” because the security of an encryption system generally relies on the key being kept secret. Mobile application package builder program 50 also encrypts the secret key using an asymmetric key algorithm. An encryption key is one key of an asymmetric key pair (comprising a public and a private key) used to encrypt the secret key using an asymmetric key algorithm. The other key (i.e., decryption key) of the asymmetric key pair is used to decrypt the secret key.

Mobile application package builder program 50 also packages mobile application 80 for distribution. In another embodiment, if mobile application package builder program 50 does not perform the packaging function, generally, an enterprise mobile build program will complete the packaging. Packaging an application for distribution is a process of binding the relevant files, components, and content to build a customized application. The files, components, and content can be placed in a container file such as a zip file or they can be placed in a file designed for distribution and installation of application software onto certain computing platforms such as Android™. Android's application package file (APK) is the file format used to distribute and install application software onto the Android operating system. In one embodiment, mobile application package builder program 50 packages encrypted unencrypted content 70 (i.e., encrypted content 120), the encrypted secret key (i.e., encrypted secret key 110), the decryption key of the asymmetric key pair (i.e., public key 100), and any other files or components necessary as completed mobile application (i.e., mobile application 80).

In one embodiment, mobile application package builder program 50 is a function of an enterprise mobile build program on enterprise server 30. An enterprise mobile build program may be a previously known program, such as IBM® Worklight, for developing mobile applications. In other embodiments, mobile application package builder program 50 may be a separate program that resides on another server or another computing device, provided that mobile application package builder program 50 is able to access application keystore 60 and unencrypted content 70, and provided that mobile application package builder program 50 can communicate with the enterprise mobile build program.

Application keystore 60 is a repository that contains an asymmetric key pair for use by mobile application package builder program 50. For example, application keystore 60 may be a keystore such as a Java KeyStore (JKS), a Certificate Management Services (CMS) keystore, or a Public-Key Cryptography Standards (PKCS#12) type keystore. In one embodiment the asymmetric key pair contained in application keystore 60 may be used to “sign” a completed mobile application that is ready for distribution and to encrypt the secret key used to encrypt unencrypted content 70. The secret key is encrypted using the encryption key (e.g., private key) of the asymmetric key pair and the decryption key (i.e., public key 100) of the asymmetric key pair is packaged with the completed mobile application (i.e., mobile application 80).

Signing is the act of creating a digital signature on a software package using a private key. The asymmetric key pair (consisting of public and private keys) may have an authority-issued certificate, a self-signed certificate, or no certificate. Certificates have no effect on the signature itself, only the trust that the signature conveys. A certificate is proof of ownership for the asymmetric key pair. A certificate issued by a certification authority (e.g., Verisign) indicates that the public/private key pair belongs to the entity described in the certificate. In general, most mobile computing platforms such as Android require mobile applications to be signed by the application's developer in order to be distributed through the application store or marketplace associated with that mobile computing platform.

In one embodiment, application keystore 60 is located on enterprise server 30. In another embodiment, application keystore 60 may be located on another server or another computing device, provided that application keystore 60 is accessible to mobile application package builder program 50.

Unencrypted content 70 is web based content to be encrypted by mobile application package builder program 50. In one embodiment, unencrypted content 70 may be files of web based application code written in cross-platform languages such as HyperText Markup Language (HTML), Cascading Style Sheets (CSS) language, or JavaScript. In other embodiments, web based content may also include images or any other type of resource not including files of native application code.

Mobile application 80 is a hybrid application that operates on client computer 40. In one embodiment, mobile application 80 is a hybrid application built and distributed by the enterprise mobile build program on enterprise server 30. Mobile application 80 contains read encrypted content program function 90, public key 100, encrypted secret key 110, and encrypted content 120.

Public key 100 is the public key, of the asymmetric key pair, used by read encrypted content program function 90 to decrypt encrypted secret key 110. Public key 100 is packaged within mobile application 80. Encrypted secret key 110 is the encrypted secret symmetric key used to decrypt encrypted content 120.

Encrypted content 120 is web based content that has been encrypted by mobile application package builder program 50. In one embodiment, encrypted content 120 may be files of web based application code written in cross-platform languages such as HyperText Markup Language (HTML), Cascading Style Sheets (CSS) language, or JavaScript. In other embodiments, web based content may also include images or any other type of resource not including files of native application code.

Read encrypted content program function 90 operates to decrypt encrypted content 120. In one embodiment, read encrypted content program function 90 decrypts encrypted secret key 110 and uses the decrypted secret key to decrypt encrypted content 120. Encrypted content 120 does not remain unencrypted; the decryption of encrypted content 120 is performed on demand for added security. In another embodiment, encrypted content 120 remains unencrypted on client computer 40 (e.g., in memory on client computer 40) so long as mobile application 80 is running Once mobile application 80 stops running the unencrypted content is removed from client computer 40.

In one embodiment, the decrypted secret key is cached on client computer 40 for use by read encrypted content program function 90 during subsequent requests to decrypt encrypted content 120. The secret key is cached so long as mobile application 80 is running Once mobile application 80 stops running the secret key is removed from the cache.

In one embodiment, read encrypted content program function 90 is a function of mobile application 80 on client computer 40. In other embodiments, read encrypted content program function 90 may be a separate program that resides on client computer 40 or another computing device, provided that read encrypted content program function 90 is able to access public key 100, encrypted secret key 110, and encrypted content 120, and provided that read encrypted content program function 90 can communicate with mobile application 80.

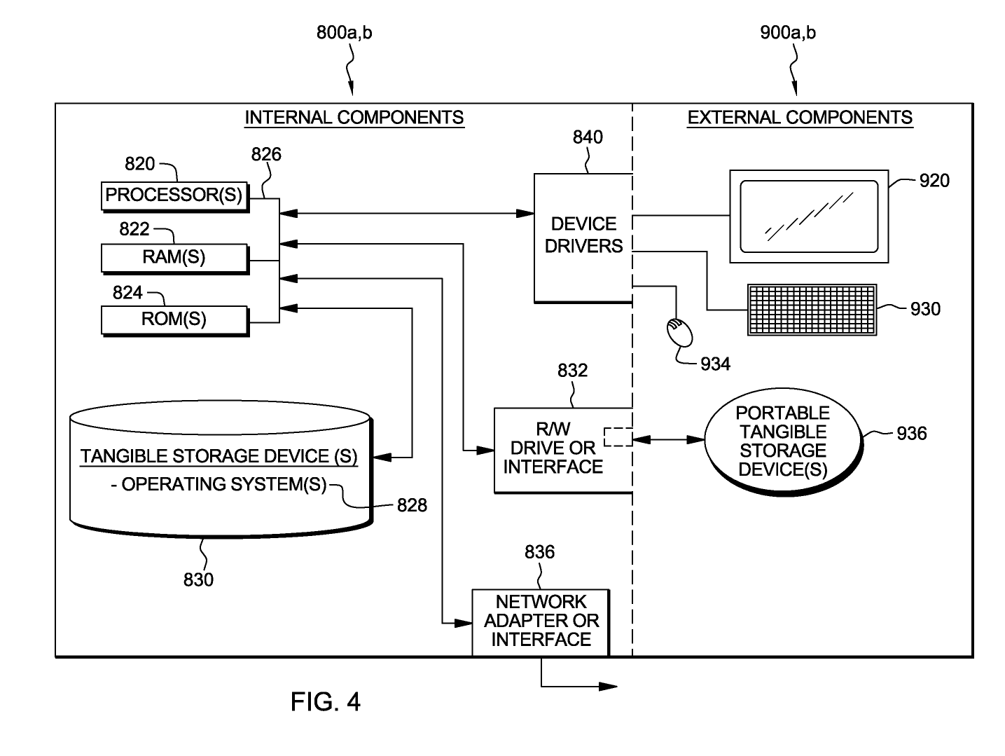

Enterprise server 30 and client computer 40 each maintain respective internal components 800a and 800b, and respective external components 900a and 900b. In general, enterprise server and client computer 40 can be any computing system as described in further detail with respect to FIG. 4.

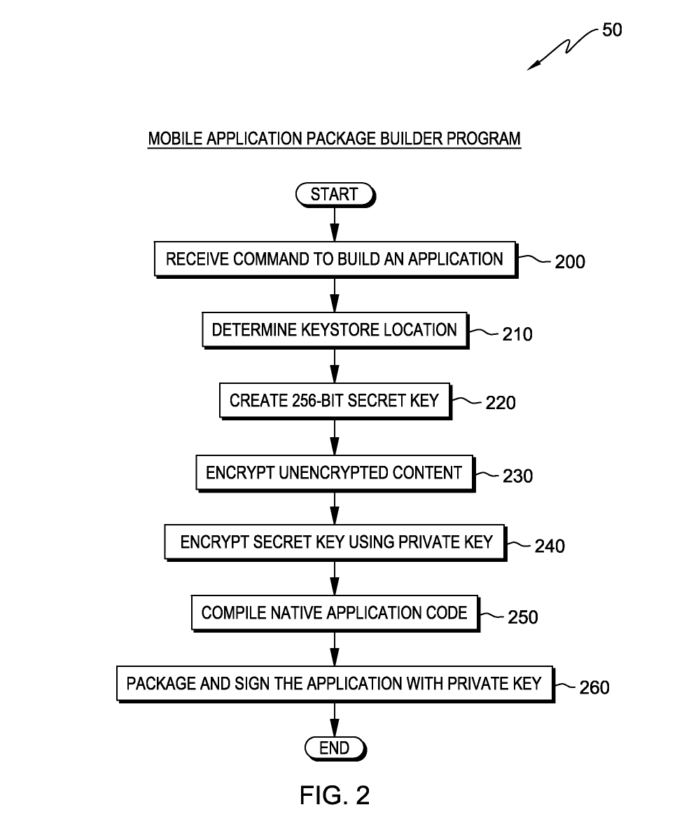

FIG. 2 depicts a flowchart of the steps of mobile application package builder program 50 executing within the computing system of FIG. 1, for encrypting web based content and packaging a mobile application, in accordance with one embodiment of the present invention.

In one embodiment, initially, a user at a terminal connected to enterprise server 30 writes the web based content in unencrypted content 70, for use in mobile application 80, using an enterprise mobile build program. The user also writes the native application code portion of mobile application 80. The native application code is saved to enterprise server 30. The user requests that unencrypted content 70 be encrypted and mobile application 80 be built. The enterprise mobile build program sends a command to mobile application package builder program 50 to encrypt unencrypted content 70 and build mobile application 80.

In step 200, mobile application package builder program 50 receives a command from the enterprise mobile build program to encrypt unencrypted content 70 and build mobile application 80.

In response to receiving the command, mobile application package builder program 50 determines the location of application keystore 60 (step 210). In one embodiment, mobile application package builder program 50 fetches a configuration file containing the location of application keystore 60 on enterprise server 30. The configuration file may be part of the enterprise mobile build program and contain the location of the keystore associated with a particular type of mobile application being built. For example, if the enterprise mobile build system is building a mobile application to run on the Android platform the configuration file will point to the location of a keystore containing the appropriate asymmetric key pair for that mobile computing platform.

In step 220, mobile application package builder program 50 creates a secret key. In one embodiment, mobile application package builder program 50 uses a built-in key derivation function (KDF) to create the secret key. The secret key may be 128, 192, or 256 bits in length, preferably 256 bits. A KDF derives a secret key from a secret value such as a master key or other known information such as a password or passphrase. For example, PBKDF2 (Password-Based Key Derivation Function 2) is a key derivation function. PBKDF2 applies a pseudorandom function, such as a cryptographic hash, cipher, or hash-based message authentication code (HMAC) to the input password or passphrase along with a salt value and repeats the process many times to produce a secret key. The inputs required for PBKDF2 may be derived from a cryptographically secure pseudo-random number generator (CSPRNG). CryptGenRandom is a cryptographically secure pseudorandom number generator function that is included in Microsoft's Cryptographic Application Programming Interface.

In step 230, mobile application package builder program 50 encrypts unencrypted content 70 using the secret key and a symmetric key algorithm. In one embodiment, the symmetric key algorithm is the Advanced Encryption Standard (AES). AES is a cipher with a 128 bit block size and it uses keys of 128, 192 or 256 bits. In other embodiments, any other known symmetric key algorithm may be used. In one embodiment, the output from mobile application package builder program 50 encrypting unencrypted content 70 is held in the memory of enterprise server 30.

In step 240, mobile application package builder program 50 encrypts the secret key using the encryption key (e.g., private key) of the asymmetric key pair and an asymmetric key algorithm. In one embodiment, mobile application package builder program 50 calls application keystore 60 to retrieve the encryption key to use with the asymmetric key algorithm. In one embodiment, the asymmetric key algorithm is RSA (Rivest-Shamir-Adleman). In other embodiments, any other known asymmetric key algorithm may be used. In one embodiment, the output from mobile application package builder program 50 encrypting the secret key is held in the memory of enterprise server 30.

In step 250, mobile application package builder program 50 compiles the native application code on enterprise server 30 for mobile application 80. In one embodiment, mobile application package builder program 50 will call the enterprise mobile build program to retrieve the native application code for mobile application 80. Mobile application package builder program 50 compiles the native application code using a built-in compiler function and stores the compiled native application code in the memory of enterprise server 30. In other embodiments, a complier function may be built-in to the enterprise mobile build program or may be a program separate from mobile application package builder program 50 and the enterprise mobile build program. A compiler is a computer program that converts code written in a programming language into another computer language (the target language, often having a binary form known as object code).

In step 260, mobile application package builder program 50 packages and signs mobile application 80 for distribution. In one embodiment, mobile application package builder program 50 places the relevant files, components, and content, including encrypted unencrypted content 70 (i.e., encrypted content 120), the encrypted secret key (i.e., encrypted secret key 110), and the decryption key of the asymmetric key pair (i.e., public key 100) into a file designed for distribution and installation of mobile application 80. Mobile application package builder program 50 calls the memory of enterprise server 30 to retrieve encrypted unencrypted content 70 (i.e., encrypted content 120), the encrypted secret key (i.e., encrypted secret key 110), and the compiled native application code. Mobile application package builder program 50 calls application keystore 60 to retrieve the decryption key of the asymmetric key pair (i.e., public key 100).

In another embodiment, the relevant files, components, and content, including encrypted unencrypted content 70 (i.e., encrypted content 120), the encrypted secret key (i.e., encrypted secret key 110), and the decryption key of the asymmetric key pair (i.e., public key 100) can be placed in a container file such as a zip file.

In one embodiment, mobile application package builder program 50 signs the file designed for the distribution and installation of mobile application 80. Mobile application package builder program 50 calls application keystore 60 to retrieve the private key of the asymmetric key pair to create a digital signature on the file designed for the distribution of mobile application 80.

In one embodiment, after the file designed for the distribution and installation of mobile application 80 is packaged and signed, mobile application package builder program 50 sends the file to an application store or marketplace associated with the mobile computing platform mobile application 80 will run on. In one embodiment, the application store or marketplace is on another server not pictured in FIG. 1. In another embodiment, enterprise server 30 may contain a private application store or marketplace that is for use only by users associated with that enterprise.

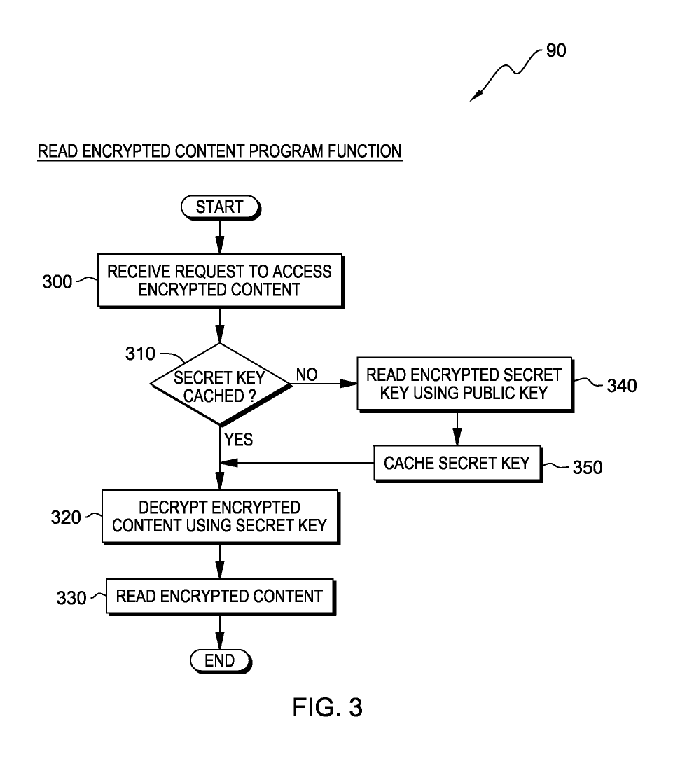

FIG. 3 depicts a flowchart of the steps of read encrypted content program function 90 executing within the computing system of FIG. 1, for decrypting encrypted web based content in a mobile application, in accordance with one embodiment of the present invention.

In one embodiment, initially, a user at client computer 40 downloads the file designed for the distribution of mobile application 80 from an application store or marketplace. Mobile application 80 is then installed onto client computer 40. During the operation of mobile application 80 the user will cause mobile application 80 to request access to encrypted content 120. In one embodiment, mobile application 80 sends a request to access encrypted content 120 to read encrypted content program function 90.

In step 300, read encrypted content program function 90 receives a request to access encrypted content 120 from mobile application 80. In response to receiving the request, read encrypted content program function 90 determines if the secret key is cached on client computer 40 (decision 310). In one embodiment, read encrypted content program function 90 calls the cache of client computer 40 to determine if the secret key is present in the cache.

If read encrypted content program function 90 determines that the secret key is cached on client computer 40, (decision 310, yes branch), read encrypted content program function 90 decrypts encrypted content 120 using the secret key and a symmetric key algorithm (step 320). In one embodiment, the symmetric key algorithm is the same as used to encrypt unencrypted content 70 in step 230, Advanced Encryption Standard (AES).

In one embodiment, the output (i.e., unencrypted content 70) from read encrypted content program function 90 decrypting encrypted content 120 is held in the memory of client computer 40. Encrypted content 120 does not remain unencrypted. Read encrypted content program function 90 removes the output (i.e., unencrypted content 70) from the memory of client computer 40 when read encrypted content program function 90 receives a notification that the output is no longer required by mobile application 80. The decryption of encrypted content 120 is performed on demand. In another embodiment, encrypted content 120 remains unencrypted on client computer 40 (e.g., in memory on client computer 40 as unencrypted content 70) so long as mobile application 80 is running Once mobile application 80 stops running the output is removed from the memory of client computer 40.

In step 330, read encrypted content program function 90 reads the output (i.e., unencrypted content 70) held in the memory of client computer 40. In one embodiment, read encrypted content program function 90 sends the output to mobile application 80.

If read encrypted content program function 90 determines that the secret key is not cached on client computer 40, (decision 310, no branch), read encrypted content program function 90 decrypts encrypted secret key 110 using public key 100 and an asymmetric key algorithm (step 340). In one embodiment, the asymmetric key algorithm is the same as used to encrypt the secret key in step 240, RSA (Rivest-Shamir-Adleman).

Read encrypted content program function 90 caches the decrypted secret key on client computer 40 for use by read encrypted content program function 90 during subsequent requests to decrypt encrypted content 120 (step 350). The secret key is cached so long as mobile application 80 is running. Once mobile application 80 stops running the secret key is removed from the cache. After the secret key is cached read encrypted content program function 90 returns to complete steps 320 and 330 as described above.

FIG. 4 is a block diagram of internal and external components of enterprise server 30 and client computer 40 in accordance with one embodiment of the present invention.

Enterprise server 30 and client computer 40 include respective sets of internal components 800a,b and external components 900a,b illustrated in FIG. 4. Each of the sets of internal components 800a,b includes one or more processors 820, one or more computer-readable RAMs 822 and one or more computer-readable ROMs 824 on one or more buses 826, one or more operating systems 828 and one or more computer-readable tangible storage devices 830. The one or more operating systems 828 and mobile application package builder program 50 are stored on at least one of one or more of computer-readable tangible storage devices 830 of internal components 800a for execution by at least one of one or more of processors 820 of internal components 800a via at least one of one or more of RAMs 822 of internal components 800a (which typically include cache memory). Application keystore 60 and unencrypted content 70 are stored on at least one of one or more of computer-readable tangible storage devices 830 of internal components 800a.

The one or more operating systems 828, mobile application 80 and read encrypted content program function 90 are stored on at least one of one or more of computer-readable tangible storage devices 830 of internal components 800b for execution by at least one of one or more of processors 820 of internal components 800b via at least one of one or more of RAMs 822 of internal components 800b (which typically include cache memory). Public key 100, encrypted secret key 110, and encrypted content 120 are stored on at least one of one or more of computer-readable tangible storage devices 830 of internal components 800b.

In the embodiment illustrated in FIG. 4, each of the computer-readable tangible storage devices 830 is a magnetic disk storage device of an internal hard drive. Alternatively, each of the computer-readable tangible storage devices 830 is a semiconductor storage device such as ROM 824, EPROM, flash memory or any other computer-readable tangible storage device that can store a computer program and digital information.

Each set of internal components 800a,b also includes a R/W drive or interface 832 to read from and write to one or more portable computer-readable tangible storage devices 936 such as a CD-ROM, DVD, memory stick, magnetic tape, magnetic disk, optical disk or semiconductor storage device. Mobile application package builder program 50, application keystore 60, and unencrypted content 70 can be stored on at least one of one or more of portable computer-readable tangible storage devices 936 of external components 900a, read via R/W drive or interface 832 of internal components 800a and loaded into at least one of computer-readable tangible storage devices 830 of internal components 800a. Mobile application 80, read encrypted content program function 90, public key 100, encrypted secret key 110, and encrypted content 120 can be stored on at least one of one or more of portable computer-readable tangible storage devices 936 of external components 900b, read via R/W drive or interface 832 of internal components 800b and loaded into at least one of computer-readable tangible storage devices 830 of internal components 800b.

Each set of internal components 800a,b also includes a network adapter or interface 836 such as a TCP/IP adapter card or wireless communication adapter (such as a 4G wireless communication adapter using OFDMA technology). Mobile application package builder program 50, application keystore 60, and unencrypted content 70 can be downloaded to enterprise server 30 from an external computer via a network (such as network 20) and network adapter or interface 836 of internal components 800a. From the network adapter or interface 836 of internal components 800a, mobile application package builder program 50, application keystore 60, and unencrypted content 70 are loaded into at least one of computer-readable tangible storage devices 830 of internal components 800a. Mobile application 80, read encrypted content program function 90, public key 100, encrypted secret key 110, and encrypted content 120 can be downloaded to client computer 40 from an external computer via a network (such as network 20) and network adapter or interface 836 of internal components 800b. From the network adapter or interface 836 of internal components 800b, mobile application 80, read encrypted content program function 90, public key 100, encrypted secret key 110, and encrypted content 120 are loaded into at least one of computer-readable tangible storage devices 830 of internal components 800b. The network may comprise copper wires, optical fibers, wireless transmission, routers, firewalls, switches, gateway computers and/or edge servers.

Each of the sets of external components 900a,b includes a display screen 920, a keyboard or keypad 930, and a computer mouse or touchpad 934. Each of the sets of internal components 800a,b also includes device drivers 840 to interface to display screen 920 for imaging, to keyboard or keypad 930, to computer mouse or touchpad 934, and/or to display screen for pressure sensing of alphanumeric character entry and user selections. The device drivers 840, R/W drive or interface 832 and network adapter or interface 836 comprise hardware and software (stored in computer-readable tangible storage device 830 and/or ROM 824).

The programs can be written in various programming languages (such as Java, C++) including low-level, high-level, object-oriented or non object-oriented languages. Alternatively, the functions of the programs can be implemented in whole or in part by computer circuits and other hardware (not shown).

Based on the foregoing, a method and program product have been disclosed for decrypting encrypted web based content in a hybrid mobile application. A program product has also been disclosed for encrypting web based content and packaging a hybrid mobile application. However, numerous modifications and substitutions can be made without deviating from the scope of the present invention. Therefore, the present invention has been disclosed by way of example and not limitation.

What is claimed is:

1. A method for decrypting web based content in a hybrid mobile application, the method comprising the steps of:
a computer receiving a first request to access encrypted content from a hybrid mobile application, and in response, the computer decrypting an encrypted secret key to expose the secret key using an asymmetric key algorithm and a decryption key of an asymmetric key pair for the asymmetric key algorithm; and
the computer decrypting the encrypted content using the secret key and a symmetric key algorithm.

2. The method of claim 1, further comprising the steps of:
the computer receiving a second request to access the encrypted content;
the computer determining that the secret key is cached on the computer; and
the computer decrypting the encrypted content using the secret key and a symmetric key algorithm.

3. The method of claim 1, further comprising the steps of:
the computer placing the encrypted content that has been decrypted in memory;
the computer receiving a notification that the encrypted content that has been decrypted is no longer needed by the hybrid mobile application, and
the computer removing the encrypted content that has been decrypted from memory.

4. The method of claim 1, further comprising the steps of:
the computer placing the encrypted content that has been decrypted in memory; and
the computer removing the encrypted content that has been decrypted from memory as the hybrid mobile application stops running.

5. The method of claim 1 further comprises the step of the computer reading the encrypted content that has been decrypted.

6. The method of claim 1, wherein the secret key comprises 256 bits.

7. A computer program product for decrypting web based content in a hybrid mobile application, the computer program product comprising:
one or more computer-readable tangible storage devices and program instructions stored on at least one of the one or more storage devices, the program instructions comprising:
program instructions to receive a first request to access encrypted content from a hybrid mobile application, and in response, program instructions to decrypt an encrypted secret key to expose the secret key using an asymmetric key algorithm and a decryption key of an asymmetric key pair; and
program instructions to decrypt the encrypted content using the secret key and a symmetric key algorithm.

8. The computer program product of claim 7, further comprising:
program instructions, stored on at least one of the one or more storage devices, to receive a second request to access the encrypted content;
program instructions, stored on at least one of the one or more storage devices, to determine that the secret key is cached on the computer; and
program instructions, stored on at least one of the one or more storage devices, to decrypt the encrypted content using the secret key and a symmetric key algorithm.

9. The computer program product of claim 7, further comprising:
program instructions, stored on at least one of the one or more storage devices, to place the encrypted content that has been decrypted in memory;
program instructions, stored on at least one of the one or more storage devices, to receive a notification that the encrypted content that has been decrypted is no longer needed by the hybrid mobile application, and
program instructions, stored on at least one of the one or more storage devices, to remove the encrypted content that has been decrypted from memory.

10. The computer program product of claim 7, further comprising:
program instructions, stored on at least one of the one or more storage devices, to place the encrypted content that has been decrypted in memory; and
program instructions, stored on at least one of the one or more storage devices, to remove the encrypted content that has been decrypted from memory as the hybrid mobile application stops running.

11. The computer program product of claim 7, further comprising program instructions, stored on at least one of the one or more storage devices, to read the encrypted content that has been decrypted.

12. The computer program product of claim 7 wherein the secret key comprises 256 bits.

13. A computer program product for encrypting web based content and packaging a hybrid mobile application, the computer program product comprising:
one or more computer-readable tangible storage devices and program instructions stored on at least one of the one or more storage devices, the program instructions comprising:
program instructions to receive a command to encrypt web based content and package a hybrid mobile application;
program instructions to create a secret key;
program instructions to encrypt the web based content using the secret key and a symmetric key algorithm;
program instructions to encrypt the secret key using an encryption key of an asymmetric key pair and an asymmetric key algorithm; and
program instructions to package the hybrid mobile application.

14. The computer program product of claim 13 further comprising program instructions, stored on at least one of the one or more storage devices, to sign the hybrid mobile application.

15. The computer program product of claim 14, wherein the program instruction to sign the hybrid mobile application comprises:
program instructions to retrieve the encryption key the asymmetric key pair; and
program instructions to create a digital signature on the hybrid mobile application using the encryption key.

16. The computer program product of claim 13, wherein the web based content comprises files of web based application code written in cross-platform languages.

17. The computer program product of claim 13 further comprising program instructions, stored on at least one of the one or more storage devices, to compile native application code for the hybrid mobile application.
